(19) United States
(12) Patent Application Publication
(10) Pub. No.: US 2002/0086583 A1
(43) Pub. Date: Jul. 4, 2002

(54) Electrical connector having combined cable attachment and shielding

(75) Inventor: Daniel T. Casey, Harrisburg, PA (US)

Correspondence Address: PERMAN & GREEN, 425 POST ROAD, FAIRFIELD, CT, 06430, US

(73) Assignee: Berg Technology, Inc.

(21) Appl. No.: 09/753,196

(22) Filed: Jan. 2, 2001

(51) Int. Cl. H01R 9/03

(52) U.S. Cl. 439/610

(57) ABSTRACT

An electrical connector for an electrical conductor cable. The connector comprises a housing, an electrical contact subassembly, a first ferrule, and a retention member. The electrical contact subassembly is connected to the housing and electrically connectable to electrical conductors in the cable. The first ferrule is adapted to be compressed onto the cable around an outer insulation of the cable. The retention member is adapted to capture the ferrule between the retention member and to exert a compression force on the ferrule towards the cable. The retention member could be a pair of inserts removably mounted to the housing or could be unitarily formed with the housing.

### BACKGROUND OF THE INVENTION

1. Field of the Invention

The present invention relates to electrical connectors and, more particularly, to a system for connecting an electrical connector to an electrical conductor cable.

2. Brief Description of Prior Developments

U.S. Pat. No. 4,272,148 discloses a shielded connector housing for use with a multiconductor shielded cable. A ferrule is located on the cable and ends of shield wires are bent back onto the ferrule. The shield wires and ferrule are compressed by a ridge of the housing as housing pieces are connected to each other. Some types of electrical connectors require an over-molded strain relief to be formed on the cable to attach to a connector housing. However, over-molding a strain relief feature onto a cable adds costs to the manufacturing process. Some other types of electrical connectors have teeth that project into the cable to form a strain relief. However, such teeth can change the impedance of the conductors in the cable. FCI USA, Inc. sells electrical connectors under the trademark METAGIG. The METAGIG connectors include a printed circuit board surrounded by shields inside a housing. There is a desire to reduce assembly costs and time for manufacturing such connectors by providing strain relief, without over-molding a strain relief onto the cable and without teeth compressing a cable, while still providing shielding for a printed circuit board, but without complicating the connection of the connector to the cable.

### SUMMARY OF THE INVENTION

In accordance with one embodiment of the present invention, an electrical connector is provided for an electrical cable. The connector comprises a housing, an electrical contact subassembly, a first ferrule, and at least one ferrule retention member. The electrical contact subassembly is connected to the housing and electrically connectable to electrical conductors in the cable. The first ferrule is adapted to be compressed onto the cable around an outer insulation of the cable. The at least one ferrule retention member is adapted to capture the ferrule therein and to exert a compression force on the ferrule towards the cable. The at least one ferrule retention member is located inside the housing.

In accordance with another embodiment of the present invention, an electrical cable assembly is provided comprising an electrical cable; and an electrical connector connected to the cable. The electrical connector comprises a housing, an electrical contact subassembly connected to the housing and electrically connected to conductors in the cable, a ferrule connected to the cable around an outer insulation of the cable, and a cable retention member mounted in the housing and surrounding the ferrule. The ferrule is compressed onto the cable and forms a compression frictional retention with the cable. The cable retention member exerts a compression force on the ferrule.

In accordance with one method of the present invention, a method of assembling an electrical connector and cable assembly is provided comprising steps of connecting a ferrule around an outer insulating cover of an electrical conductor cable by compressing the ferrule; connecting contacts to electrical conductors of the cable; locating a retention member around the ferrule; and inserting the retention member, the ferrule, the contacts and a portion of the cable into a connector housing, wherein the housing presses the retention member inwardly to exert a compression force onto the ferrule and to retain the ferrule inside the housing.

### BRIEF DESCRIPTION OF THE DRAWINGS

The foregoing aspects and other features of the present invention are explained in the following description, taken in connection with the accompanying drawings, wherein:

FIG. 1 is a perspective view of a connector and cable assembly having an electrical connector incorporating features of the present invention;

FIG. 2 is an exploded perspective view of the assembly shown in FIG. 1;

FIG. 3 is a schematic cross-sectional view of parts of the assembly shown in FIG. 1;

FIG. 4, is a schematic cross-sectional view of parts of an alternate embodiment of the present invention;

FIG. 5 is a schematic partial cross-sectional view of an alternate embodiment of the present invention;

FIG. 6 is a schematic partial cross-sectional view of the another alternate embodiment of the present invention;

FIG. 7 is a partial cross-sectional view of another alternate embodiment;

FIG. 8 is perspective view of an alternate embodiment of the present invention; and

FIGS. 9A and 9B are exploded perspective views of an alternate embodiment of the present invention.

### DETAILED DESCRIPTION OF THE PREFERRED EMBODIMENTS

Referring to FIG. 1, there is shown a perspective view of an electrical connector and cable assembly 10 having an electrical connector 12 incorporating features of the present invention. Although the present invention will be described with reference to the embodiments shown in the drawings, it should be understood that the present invention can be embodied in many alternate forms of embodiments. In addition, any suitable size, shape or type of elements or materials could be used.

The assembly 10 generally comprises the connector 12 and a cable 14. The connector 12 is connected to one end of the cable. The other end of the cable 14 could be connected to another connector or an electronic device (not shown). Referring also to FIG. 2, the cable 14 includes four conductors 16, each having its own insulation 18, a conductive shield or braid 20 and an outer insulation 22. In alternate embodiments, any suitable type of cable could be provided, and the cable could have more or less than four conductors. In this embodiment the shield 20 compresses a metal braid. However, in alternate embodiments any suitable type of shielding could be provided. A portion of the outer insulation 22 is removed at the end of the cable and the braid 20 has been folded back. Insulation 18 has been removed from the conductors 16 at their ends.

The connector 12 generally comprises a housing 24, a contact subassembly 26, a printed circuit board 28, at least one insert 30 and a ferrule 32. In this embodiment the housing 24 comprises three housing pieces 34, 35, 36. However, in alternate embodiments the housing could comprise more or less housing pieces. The printed circuit board 28 can have pads 38 on its top and bottom sides. Individual ones of the conductors 16 are connected to the pads 38 in a known manner. A front end 40 of the board 28 is located in a receiving slot 46 of a support 48 of the contact subassembly 26 with contact pads 44 on the front end 40 being electrically connected to contacts 42 of the subassembly 26. Thus, the conductors 16 are connected to the contacts 42 by the board 28. However, in alternate embodiments, any suitable printed circuit board or other circuit substrate could be provided, or the connector might not have a printed circuit board. In addition, in alternate embodiments any suitable connection of the conductors 16 to the contacts 42 could be provided. The contact subassembly 26 and part of the board 28 are located inside the front housing piece 34. However, in alternate embodiments, any suitable contact subassembly or contacts could be provided. The front housing piece 34 includes a cantilevered deflectable latch 50. A rear end 52 of the latch 50 abuts against a stop 54 of the top rear housing piece 35 in a rest position. A portion 56 of the latch 50 is adapted to be contacted by a finger of a user to depress or deflect the latch to an unlatched position. However, in alternate embodiments any suitable front housing piece or latching system could be provided.

Referring also to FIG. 3, the two rear housing pieces 35, 36 capture the inserts 30, front end of cable 14, and portions of the board 28 and front housing piece 34 therebetween. The two rear housing pieces 35, 36 are preferably cast metal parts fixedly connected to each other by fasteners, such as screws. However, any suitable fastening system could be used. The rear housing pieces 35, 36 press the inserts 30 towards each other. The rear housing pieces 35, 36 have recesses 58 at their rear ends which are preferrably precisely sized and shaped for the outer diameter of the cable. However, the recesses 58 might be slightly larger or smaller.

The ferrule 32 is preferrably comprised of metal, but any suitable conductive material could be used. The inner diameter of the ferrule 32 is preferably about the same size as the outer diameter of the cable 14, but could be slightly larger or smaller. The ferrule 32 is preferably compressed or crimped onto the cable 14. However, even after compression of the ferrule onto the outer insulation 22 of the cable 14, the inner diameter of the ferrule 32 is only slightly less than the outer diameter of the outer insulation 22 before compression of the ferrule. In addition, the interior of the ferrule 32 is smooth. Therefore, the outer insulation 22 is not pierced into by the ferrule and the ferrule 32 only slightly compresses the outer insulation 22. Preferably, the compression of the ferrule 32 is substantially uniform along a majority of the length of the ferrule. Thus, a substantially uniform frictional retention is provided between the inner surface of the ferrule and the outer insulation 22. However, in alternate embodiments any suitable attachment of the ferrule to the cable could be provided. In alternate embodiments more than one ferrule could be provided. The ferrule 32 is slid onto the cable 14 and crimped thereto. Then, the shield 20 is folded back onto the outer surface of the ferrule.

The insert 30 preferably comprises two inserts 30 formed of cast metal members. However, in alternate embodiments the inserts could include any number of inserts and may be comprised of any suitable conductive material and could be formed by any suitable process. However, the inserts preferably comprise ferromagnetic material. In this embodiment the connector 12 has two of the inserts, but more than two inserts could be provided. In this embodiment the inserts are substantially mirror images of each other. However, in alternate embodiments, the inserts could have different shapes. In the embodiment shown, each insert comprises a main channel 60 with a center section 62, a front section 64 and a rear section 66. The main channel 60 is deeper at the center section 62 than the front and rear sections. In a preferred embodiment, when the two inserts 30 are pressed against each other by the housing 24, the rear sections 66 form an aperture having a diameter which is about the same size as, or slightly less than, the outer diameter of the cable 14. In addition, the center sections 62 combine to form an area with a diameter that is less than the diameter of the cable/ferrule/shield (14/30/20) between the center sections 62. Therefore, the center sections 62 compress the exposed portion of the shield 20 inward against the outer side of the ferrule 32. This results in the exposed folded back portion of the shield 20 being clamped between the inserts 30 and the ferrule 32.

Because the shield 20 is clamped between the ferrule 32 and the inserts 30, this interlocks the cable 14 with the inserts 30. This allows the ferrule 32 to be attached to the outer insulation 22 of the cable 14 by a general uniform circular crimp. Such crimp secures ferrule 32 to cable 14 without an excessively large or deep compression, without piercing into the outer insulation, and without damaging the braid. The combination of the shield 20 being clamped between the ferrule 32 and the inserts 30, as well as the moderate crimp or compression of ferrule 32 on the outer insulation for a frictional retainment, provide sufficient forces to retain the ferrule 32 and cable 14 together. The surface 68 at the front end of the rear section 66 forms a stop surface for contacting the rear end of the ferrule 32. This prevents the cable 14 from being pulled out of the connector 12. The rear sections 66 also form a strain relief for the cable 14, but without piercing into the outer insulation 22 and without the need for over-molding a strain relief section onto the cable. With the embodiment described above, the ferrule 32 functions as an inner ferrule and the inserts 30 function as an outer ferrule to seal off or shield the cable and, at the same time, form a cable strain relief. The interlocking of the ferrules and the cable reduces the amount of EMI.

This embodiment, unlike other connectors which allow pull forces to be distributed through the cable and conductors, allows pull forces on the cable to be distributed through the inserts to the housing. The present embodiment also allows for a more even distribution of the braid shielding 20; unlike existing designs which cut into the braid. With the present invention, the ferrule, inserts and housing do not significantly damage, crush or kink the cable and, therefore, will not change impedance of the conductors.

This is particularly important as signal speeds increase. In a preferred method of manufacturing the assembly 10, the inserts 30 and ferrule 32 are selected from a plurality of different size inserts and ferrules for different size cables, such that the inserts and ferrule provide the strain relief and anti-pullout features for the cable as described above.

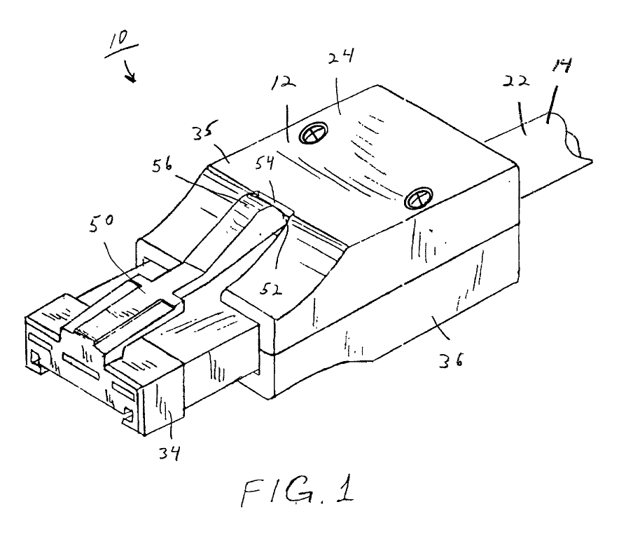

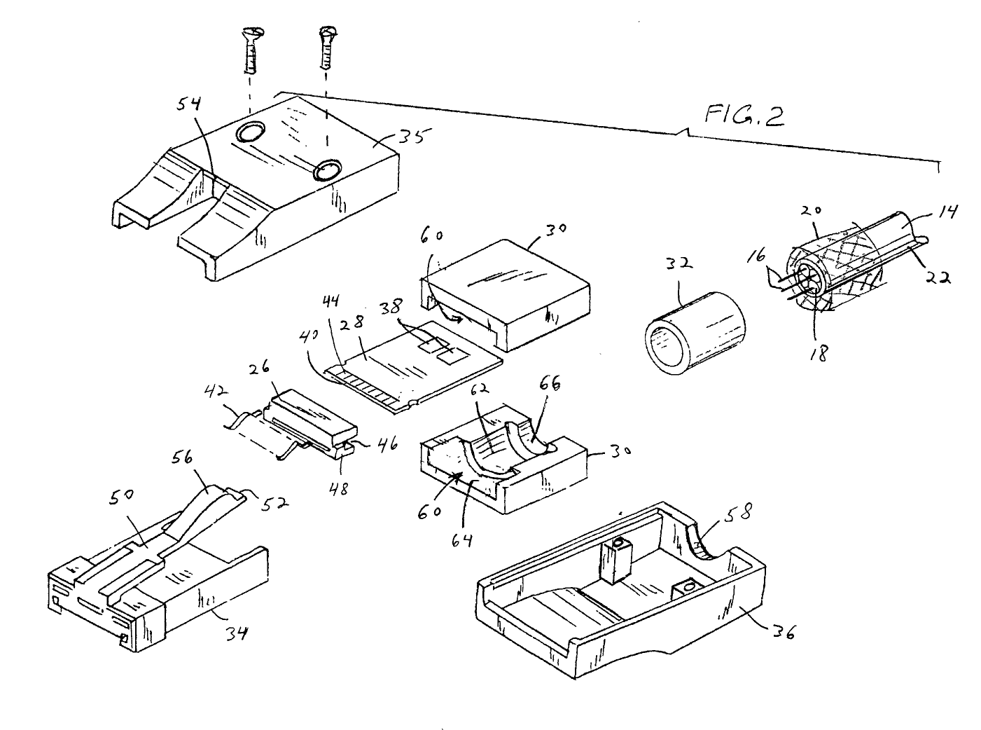

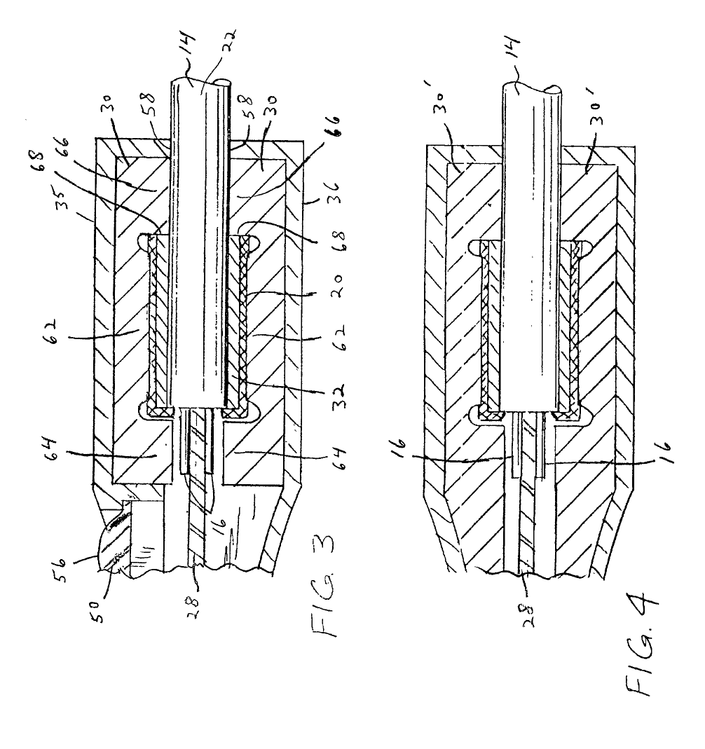

In this embodiment the front sections 64 surround the exposed ends of the conductors 16 and the rear part of the board 28. The surfaces 70 form a stop for the front end of the ferrule 32. Because the inserts preferrably comprise ferromagnetic material and are electrically connected to the shield 20, they form a shield surrounding the connection of the conductors 16 onto the pads 38. FIG. 4 shows an alternate embodiment wherein the inserts 30′ extend forward past the connection of the conductors 16 to the board 28 to provide a shield for a longer length of the board 28.

Referring now to FIG. 5, an alternate embodiment of the present invention is shown. In this embodiment the connector comprises two inserts 70, an inner ferrule 72 and an outer ferrule 74. The inner ferrule 72 is slid onto the outer insulation of cable and crimped thereto. The shield 20 is folded back onto the inner ferrule 72. The outer ferrule 74 is then placed over the shield 20 and the inner ferrule 72 and crimped or compressed. The inner ferrule prevents the cable from being crushed when the outer ferrule is compressed. The two ferrule fixedly sandwich the exposed shield 20 therebetween. With this embodiment the inserts 70 do not need to press against the shield or ferrule(s), but can still be located against the outer insulation 22 of the cable 14 at their rear ends 76 to form a strain relief.

Referring now to FIG. 6, another alternate embodiment is shown. In this embodiment the shield 20 of the cable 14 is folded back onto the outer insulation 22 and the ferrule 78 is placed over the exposed shield 20. The ferrule 78 is then compressed onto the shield 20. Because of the irregular surface of the shield 20, the ferrule 78 forms a good frictional engagement with the shield 20 to help assist is preventing the ferrule from sliding off of the exposed shield 20. In addition, the inserts 80 are pressed towards each other to provide a compression force against the ferrule 78. This compression force is distributed by the ferrule 78 against the shield 20 and, thus, against the cable, but as a more evenly distributed compression force to prevent deformation of the cable 14 which might otherwise change conductor impedance. The inserts 80 have stop surfaces 82 for contacting the rear end of the ferrule 78 and preventing pull-out. The inserts 80 also include surfaces 84, 86 which contact the outer insulation 22 of the cable 14 and form a strain relief.

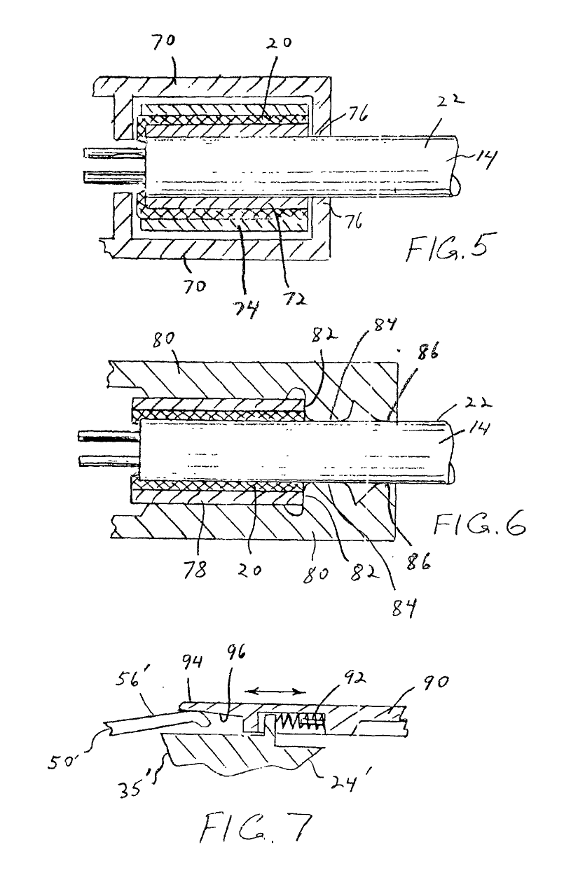

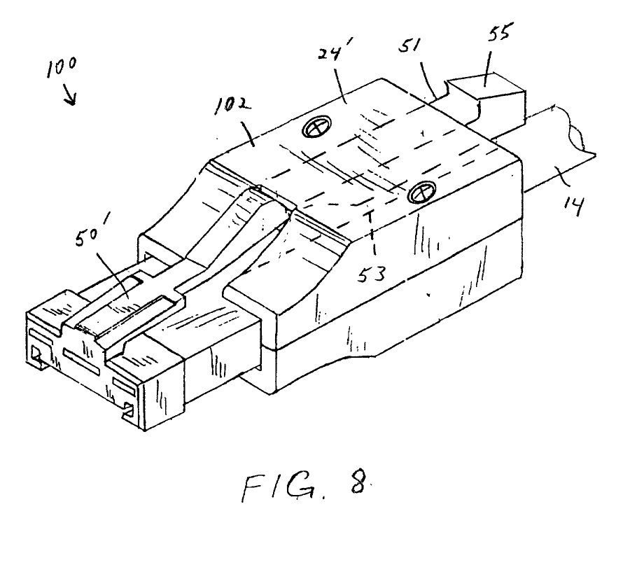

Referring now to FIG. 7, another feature of the present invention is shown. In this embodiment the housing 24′ includes an actuator or slider 90 attached to the top rear housing piece 35′. In this embodiment the slider 90 is biased in a rearward position by a spring 92. However, in an alternate embodiment a spring might not be provided or any suitable type of spring could be used. The front end 94 of the slider 90 has a bottom surface 96 which is ramp shaped. The surface 96 contacts the latch 50′ proximate the finger contact section 56′. When the slider 90 is slid forward on the housing piece 35′, the ramp surface 96 deflects the latch 50′ downward. The slider 90 may extend to the rear end (not shown) of the housing 24′. With this feature, the user can deflect the latch 50′ by either directly pressing against the finger contact section 56′ or by moving the slider 90 forward. Use of the slider 90 can be beneficial when another connector or item is located directly above the finger contact section 56′ which prevents a user from directly contacting the finger contact section 56′ with his or her finger. However, the user does not need to use the slider 90 if the finger contact section 56′ is accessible. In alternate embodiments any suitable type of remote delatching actuator could be used.

Referring now to FIG. 8, a perspective view of an alternate embodiment of the present invention is shown. In this embodiment the assembly 100 generally comprises the connector 102 and the cable 14. The connector 102 is substantially similar to the connector 12, but the latch 50′ includes a rear end extension 51. The housing 24′ has a recess 53 which the rear end extension 51 is located in and is movable up and down in. The extension 51 has a user contact section 55 which extends out of the rear end of the housing 24′. A user can depress the user contact section 55 to move the latch 50′ downward to thereby disengage the latch 50′ from the mating socket (not shown).

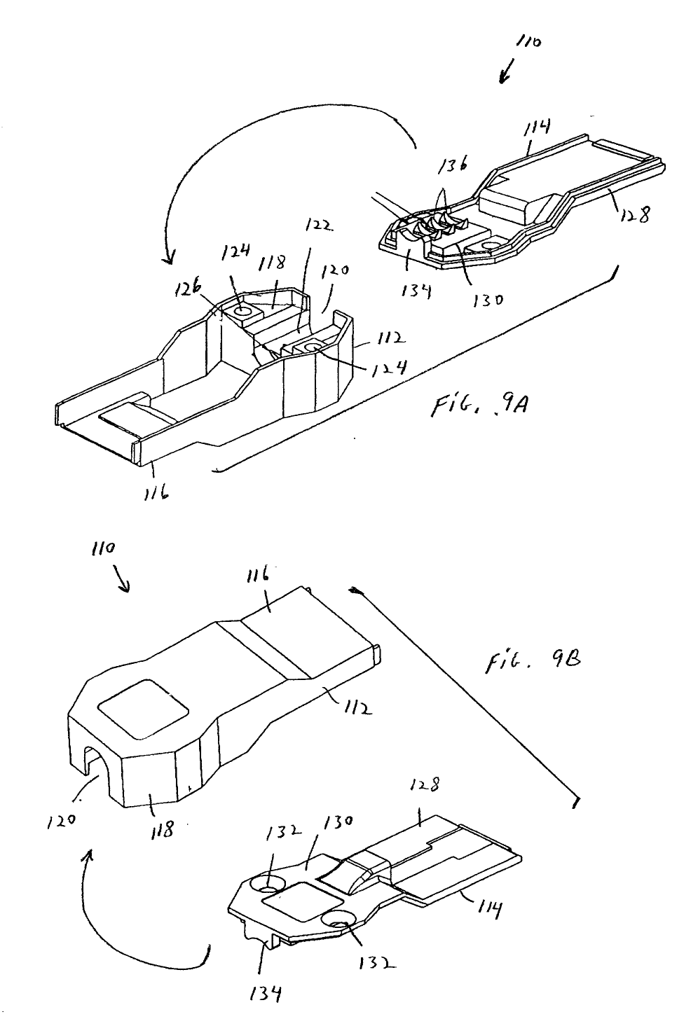

Referring now to FIGS. 9A and 9B, another embodiment of the present invention is shown. In this embodiment the connector comprises a member 110 which forms both the housing and the retention for the ferrule and cable. The combined member 110 generally comprises a bottom member 112 and a top member 114. The two members 112, 114 are both preferably provided as one piece members and are comprised of cast conductive metal. The bottom member 112 generally comprises a housing section 116 and an integrally formed retention section 118. The retention section 118 has an rear end aperture 120, a cable receiving area 122, and two fastener receiving holes 124. The cable receiving area 122 has projections 126. The top member 114 generally comprises a housing section 128 and an integrally formed retention section 130. The retention section 130 has two fastener receiving holes 132, a rear end extension 134 and projections 136. When the two members 112, 114 are assembled, the projections 126, 136 can clamp onto an inner ferrule surrounding the cable; similar to that shown in FIGS. 3-6. This embodiment illustrates that the ferrule/cable retention feature does not need to be provided as separate inserts, but could be integrally formed with the rest of the housing members.

It should be understood that the foregoing description is only illustrative of the invention. Various alternatives and modifications can be devised by those skilled in the art without departing from the invention. Accordingly, the present invention is intended to embrace all such alternatives, modifications and variances which fall within the scope of the appended claims.

What is claimed is:

1. An electrical connector for an electrical cable, the connector comprising:
a housing;
an electrical contact subassembly connected to the housing and electrically connectable to electrical conductors in the cable;
a first ferrule adapted to be compressed onto the cable around an outer insulation of the cable; and
at least one ferrule retention member adapted to capture the ferrule therein and to exert a compression force on the ferrule towards the cable, wherein the at least one ferrule retention member is located inside the housing.

2. An electrical connector as in claim 1 wherein the at least one ferrule retention member forms a blocking surface located behind a rear end of the ferrule.

3. An electrical connector as in claim 1 wherein the at least one ferrule retention member directly contacts a portion of the outer insulation of the cable.

4. An electrical connector as in claim 1 wherein the at least one ferrule retention member forms a pocket with the ferrule located in the pocket.

5. An electrical connector as in claim 1 wherein the at least one ferrule retention member extends around a portion of the electrical contact subassembly.

6. An electrical connector as in claim 1 wherein the at least one ferrule retention member comprises two inserts which are substantially mirror images of each other and are removably mounted to the housing.

7. An electrical connector as in claim 1 wherein the at least one ferrule retention member is comprised of cast metal.

8. An electrical connector as in claim 7 wherein the at least one ferrule retention member is unitary with the housing.

9. An electrical connector as in claim 1 further comprising a second ferrule coaxially arranged with the first ferrule.

10. An electrical connector as in claim 1, wherein the housing comprises a cantilevered deflectable latch and a slide movably mounted to the housing for moving the latch, wherein the latch can be deflected directly by contact with a user or by the user moving the slide.

11. An electrical cable assembly comprising:
an electrical cable; and
an electrical connector connected to the cable, the electrical connector comprising:
a housing;
an electrical contact subassembly connected to the housing and electrically connected to conductors in the cable;
a ferrule connected to the cable around an outer insulation of the cable, the ferrule being compressed onto the cable and forming a compression frictional retention with the cable; and
a cable retention member mounted in the housing and surrounding the ferrule, wherein the cable retention member exerts a compression force on the ferrule.

12. An assembly as in claim 11 wherein the cable retention member forms a blocking surface located behind a rear end of the ferrule.

13. An assembly as in claim 11 wherein the cable retention member contacts a portion of the outer insulation of the cable directly therebetween.

14. An assembly as in claim 11 wherein the cable retention member forms a pocket with the ferrule located in the pocket.

15. An assembly as in claim 11 wherein the cable retention member extends around a portion of the electrical contact subassembly.

16. An assembly as in claim 11 wherein the cable retention member comprises two inserts which are substantially mirror images of each other and are removably mounted in the housing.

17. An assembly as in claim 11 wherein the cable retention member is comprised of cast metal members.

18. An assembly as in claim 17 wherein the cable retention member is unitary with the housing.

19. An assembly as in claim 11 further comprising a second ferrule coaxially arranged over the first ferrule.

20. An assembly as in claim 11 wherein the housing comprises a cantilevered deflectable latch and a slide movably mounted to the housing for moving the latch, wherein the latch can be deflected directly by contact with a user or by the user moving the slide.

21. An assembly as in claim 12 wherein a braid of the cable is located directly between the ferrule and the cable retention member.

22. An assembly as in claim 11 wherein a braid of the cable is located directly between the ferrule and the outer insulation of the cable.

23. An assembly as in claim 11 wherein the ferrule has an inner diameter after being compressed onto the cable which is substantially the same as an outer diameter of the outer insulation before the ferrule is compressed.

24. An assembly as in claim 11 wherein the ferrule comprises a substantially constant inner diameter after being compressed onto the cable.

25. A method of assembling an electrical connector and cable assembly comprising steps of:
connecting a ferrule around an outer insulating cover of an electrical conductor cable by compressing the ferrule;
connecting contacts to electrical conductors of the cable;
locating a retention member around the ferrule; and
inserting the retention member, the ferrule, the contacts and a portion of the cable into a connector housing, wherein the housing presses the retention member inwardly to exert a compression force onto the ferrule and to retain the ferrule inside the housing.

26. A method as in claim 25 wherein the step of locating the retention member around the ferrule further comprises the retention member directly contacting the outer cover of the cable at a location behind the ferrule.

27. A method as in claim 25 further comprising locating a braid of the cable directly between the ferrule and the retention member, the braid being compressed between the retention member and the ferrule.

28. A method as in claim 25 wherein the step of locating the retention member comprises locating a portion of the retention member directly behind a rear end of the ferrule.

29. A method as in claim 25 wherein a printed circuit board connects the contacts to the conductors, and wherein the step of locating the retention member comprises the retention member surrounding the printed circuit board.
